(19) United States
(12) Patent Application Publication
(10) Pub. No.: US 2008/0267486 A1
(43) Pub. Date: Oct. 30, 2008

(54) METHODS FOR SELECTING CELLS WITH ENHANCED GROWTH AND PRODUCTION PROPERTIES

(75) Inventor: Gregory Van Slyke, North Bethesda, MD (US)

Correspondence Address: INVITROGEN CORPORATION;C/O INTELLEVATE, P.O. BOX 52050, MINNEAPOLIS, MN, 55402, US

(73) Assignee: INVITROGEN CORPORATION, Carlsbad, CA (US)

(21) Appl. No.: 12/040,800

(22) Filed: Feb. 29, 2008

Related U.S. Application Data
(60) Provisional application No. 60/892,695, filed on Mar. 2, 2007.

(51) Int. Cl. G06K 9/00

(52) U.S. Cl. 382/133

(57) ABSTRACT

The disclosure relates generally to cell biology and more specifically to mechanical manipulation of cells. Methods are provided which allow robotic devices to select cell colonies that have optimum growth and bioproduction qualities resulting in a collection of cell lines that have a much higher proportion of desired growth and production characteristics. These methods greatly reduce the time and effort needed to identify cell lines with optimum combinations of viability, growth and bioproduction properties. In some embodiments, the robotic device is able to measure multiple characteristics of the colonies and use these results to select the desired colonies.

### BACKGROUND OF THE INVENTION

1. Field of the Invention

The invention relates generally to cell biology and more specifically to mechanical manipulation of cells. Methods are disclosed which allow selection of cell clones with improved growth rate, viability and increased production of molecules of interest.

2. Background Information

Cells are frequently used to produce biomolecules of interest for use as research reagents, diagnostic tools, drugs, etc. These biomolecules may be native to the cell or heterologus to the cell having been introduced into the cell by recombinant DNA technology. In either event, it is desirable to isolate particular clones within the population of cells which have the best growth characteristics and are the most efficient at producing a molecule of interest.

In order to improve the growth and/or bioproduction capabilities of a cell line the cell may be genetically modified using a variety of techniques including but not limited to mutagenesis and various molecular biological techniques such as modifying promoters, inserting genetic constructs at different positions within the genome, modifying copy number of a gene etc. When these methods are used, a population of cells is produced comprising cells with differing properties. The individual members of the population may be isolated and characterized so that the cell line with the best properties can be identified.

There are several approaches to isolating and characterizing cells for this purpose. One is limiting dilution, where single cells are placed in the well of a multi-well culture plate and expanded. Once the cells are grown up their growth and bioproduction characteristics can be evaluated. This approach has the disadvantage of being time consuming and labor intensive.

Another option is to use a fluorescence activated cell sorter to isolate individual cells that have been tagged with a relevant marker, for example a fluorescently labeled antibody recognizing the molecule of interest. This approach has the disadvantage that you cannot evaluate the growth characteristics of the cells until they have been expanded after sorting.

A third approach is to grow the cells in a semisolid medium or on a solid support such that colonies of cells derived from individual cells are produced. These colonies can be picked and expanded and evaluated for growth and bioproduction properties. This approach has the disadvantage of being tedious and labor intensive. To overcome this problem robotic devices have been developed which can automatically detect and pick colonies and transfer them to multi-well culture plates for expansion. This approach greatly reduces the labor involved but still requires that a large number of clones be evaluated for growth and bioproduction properties.

### SUMMARY OF THE INVENTION

The present invention provides methods which allow robotic devices to select colonies of cells that have optimum growth and bioproduction qualities resulting in a collection of cell lines that have a much higher proportion of the desired growth and production characteristics. These methods greatly reduce the time and effort needed to identify cell lines with the optimum combination of viability, growth and bioproduction properties. In some embodiments of the invention, the robotic device is able to measure multiple characteristics of the colonies and use these results to select the desired colonies.

In some embodiments, the robotic device may be able to measure the size and shape of individual colonies. In a further embodiment the robotic device may be able to estimate the amount of the molecule of interest produced by each colony. In still further embodiments the colonies are contacted with a labeled probe such as an antibody specific for the molecule of interest. Examples of a molecule of interest include but are not limited to proteins, antibodies, enzymes, receptors, peptides hormones, growth factors and nucleic acids. In particular embodiments, the label is a fluorescent, calorimetric or luminescent compound.

Some embodiments of the invention may include a method for the automated selection of colonies of cells with enhanced production of a molecule of interest. Such a method may comprise providing cell colonies in a semi-solid medium or on a solid support. In many embodiments cells are grown in a semi-solid medium as this makes detecting secreted molecules easier, however some cells may have specific growth requirements that require the use of a solid support. In some embodiments, the method further comprises contacting cells with a labeled probe capable of binding the molecule of interest. In many embodiments, the labeled probe may be an antibody conjugated with a detectable label such as a fluorescent, calorimetric or luminescent molecule or an enzyme that catalyzes the production of a fluorescent, calorimetric or luminescent molecule.

The labeled probe is not limited to a conjugated antibody molecule. Any molecule that exhibits specific binding, directly or indirectly, to the molecule of interest may be used as a labeled probe. Examples of probes may include, but are not limited to, antibody fragments, peptides, nucleic acids, lectins, receptors, and DNA binding proteins.

In some embodiments, the method also comprises placing the cell colonies in a robotic device having an image capturing function and imaging the cell colonies using white light and at a wavelength of light passed by a narrow bandwidth filter. Imaging the colonies using white light allows the size and shape of the colony to be evaluated. A small colony may be indicative of slow growth and an asymmetrical colony may indicate a colony that arose from more than a single cell. Colonies that are two close to each other may also not be selected because they may not be separable during the picking process.

In some embodiments, the method further comprises selecting cell colonies having a size greater than a desired minimum size based on the white light image. Because the size of a colony may be associated with growth rate, a threshold minimum size may be set. This threshold size may eliminate slow growing colonies from the pool of colonies under consideration for picking. This method may further comprise selecting from the population of cell colonies having the desired minimum size based on the white light image, cell colonies having a size greater than a minimum size based on the narrow bandwidth filtered image. In many embodiments, the narrow bandwidth filtered image may be detecting a fluorescent, calorimetric or luminescent label with an emission spectra corresponding to the bandwidth of the filter. For a molecule of interest that remains membrane bound, the brightness of the colony may correlate with the amount of the molecule of interest that is produced by the colony. In embodiments where the molecule of interest is secreted into the medium, the volume of the fluorescence or luminescence may correlate with the amount of the molecule that is produced by the colony. By setting a minimum threshold of brightness and/or volume of the colony imaged using a specific wavelength of light, colonies that produce low amounts of the molecule of interest may be eliminated from the pool of those considered for picking.

Multiple labeled probes may be used if the excitation and/or emission spectra of each label is unique. These embodiments allow multiple parameters of the colony to be evaluated. For example, the production of a molecule of interest may be evaluated along with the production of a contaminate molecule.

In selecting colonies for picking, a single parameter such as white light volume or fluorescence volume may be considered. In other embodiments, two or more parameters may be combined, for example a ratio of one parameter over another may be calculated and used to select colonies for picking. In many embodiments, two or more parameters are considered sequentially. In these embodiments, a threshold value may be set for each parameter so that every colony considered for picking may be above or below each threshold as desired.

### BRIEF DESCRIPTION OF THE DRAWINGS

FIG. 1 is a perspective view of a portion of one example of a robotic device that may be used in the practice of the invention.

FIG. 2 is a block diagram showing one example of a process carried out by the robotic device.

FIG. 3 illustrates colonies grown in a semi-solid medium and imaged with white light.

FIG. 4 illustrates the distribution of selected colonies by productivity of IgG after selection using white light.

FIG. 5 illustrates the distribution of selected colonies by productivity of IgG after selection using the sequential method.

### DETAILED DESCRIPTION OF THE INVENTION

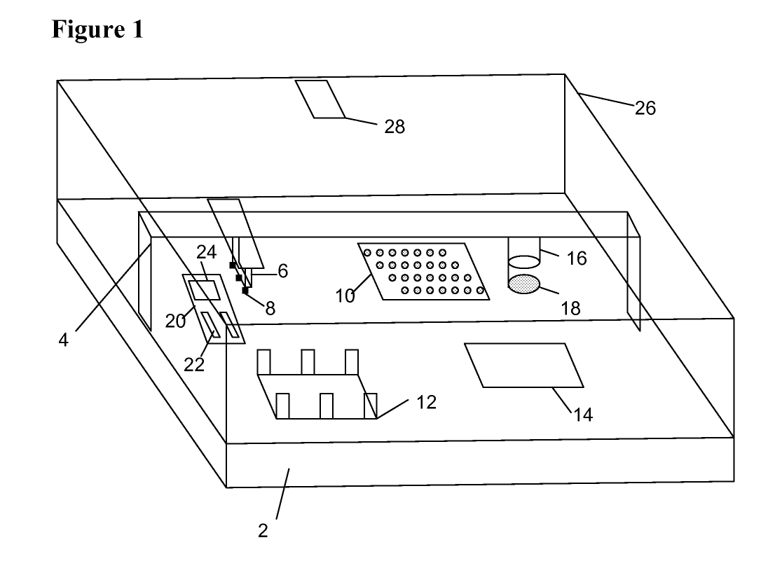

Embodiments of the present invention use a robotic device to image cell colonies in a semi-solid medium or on a substrate and to pick selected colonies and transfer them to a multi-well culture plate. A portion of such a device is illustrated in FIG. 1 and comprises a platform 2 on which is mounted a raised rail 4. On the rail is mounted a clone picking head 6 which is capable of movement along the axis of the rail and perpendicular to the axis of the rail. The clone picking head is comprised of one or more hollow pins 8. Each of the hollow pins is connected to a fluid line which allows for aspiration and dispensing of a cell colony sample to a well of a multi-well plate 10 or other target. In some embodiments, individual hollow pins are capable of lateral movement so that they may dislodge colonies attached to a substrate.

The platform further comprises an apparatus 12 for the manipulation of one or more culture plates which contain the cell colonies prior to analysis and colony picking. The apparatus is configured such that it can move a culture plate from the clone picking head to a light source 14. The light source may be a light emitting diode or laser or other device capable of emitting light of a wavelength suitable for the fluorescent or luminescent label being used. Adjacent to the light source 14 may be a digital camera 16 for imaging the culture plate. Interspersed between the light source 14 and digital camera 16 may be a bandpass filter 18 which may be configured to allow light to pass unfiltered or to filter all but a selected narrow wavelength band suitable for the fluorescent or luminescent label being used.

Also mounted on the platform may be a washing station 20 for the hollow pins. The washing station may be used to clean the hollow pins between picking operations to prevent cross contamination. The washing station may be comprised of one or more baths 22 in which the hollow pins are immersed and a drying station 24 for removing any residual liquid from the hollow pins.

The platform may be enclosed by a gas-tight cover 26 which further comprises a high-efficiency particulate (HEPA) filter 28. The HEPA filter provides an environment that is substantially free of contaminating particles and allows the picked colonies to be transferred to a multi-well culture plate without contamination.

The operation of the robotic device is controlled by a computer, which is connected to the device by standard electronic interfaces. The computer may be comprised of one or more input devices such as a keyboard, mouse or touch screen and one or more output devices such as a screen or printer. The computer further comprises a central processing unit for executing program code and a data storage device such as a disk drive for the storage of data program code.

Robotic devices suitable for practicing the invention are commercially available. One such instrument is the CLONEPIX FL™ available from Genetix USA Inc. (Boston, Mass.). Suitable robotic devices are also described in U.S. patent application Ser. Nos. 10/631,845 and 11/401,966 which are incorporated herein by reference in their entirety.

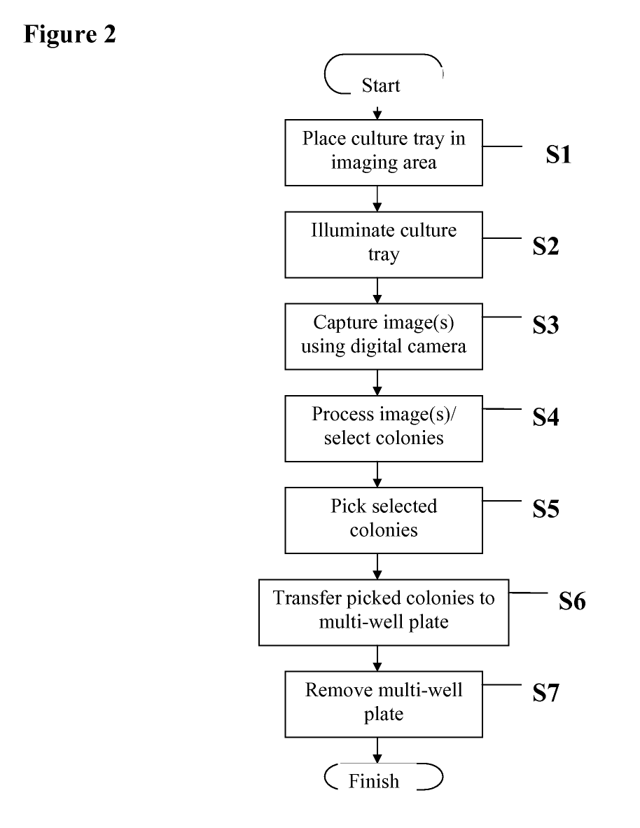

FIG. 2 shows a flowchart of an example embodiment of the invention. S1 The culture plate is placed in the imaging area, for example in the apparatus 12 for the manipulation of culture plates. S2 The culture plate is moved to the light source 14 and illuminated. S3 One or more images are captured by the digital camera 16. S4 The image(s) are processed and the colonies for picking are selected. The bandpass filter 18 may be used to control the wavelength of light captured by the camera. S5 The clone picking head 6 positions a hollow pin 8 over an individual selected colony and the hollow pin 8 is used to pick the colony by aspiration. S6 The picked colonies are deposited into individual wells of the multi-well culture plate 10. S7 The multi-well culture plate 10 is removed for incubation. The length of time cells are incubated before further analysis is carried out will depend on the growth characteristics of the particular cell but may typically be 4-12 days.

For the growth of colonies to be selected and picked, a semi-solid medium may be used. The medium selected should support the growth of the cells and may typically comprise an approximately 0.5% concentration of agar to provide the structural rigidity to the medium so that distinct colonies are formed and immobilized. While agar is typically used, other materials that are non-toxic to cells may also be used. Suitable media are available from commercial sources. For example, CLONEMATRIX™ from Genetix USA Inc. (Boston, Mass.) catalog number K8500.

In alternative embodiments, anchorage dependent cells or other cells that show improved growth may be grown on a substrate immersed in culture media. Suitable substrates include but are not limited to collagen, extracellular matrix, fibronectin and luminin. In these embodiments, the colony may be dislodged from the substrate by lateral movement of the hollow pin before aspiration of the colony.

The cell colonies may be human cell colonies or other mammalian cell colonies, or insect cell colonies. The cells may be immortal, embryonic CHO, 293, hybridoma, antibody producing or stem cells, for example. Typically, the cell colonies will be grown in tissue culture.

Imaging of the cell colonies may be performed by the digital camera using a white light source or a light source emitting a specific wavelength of light. The imaging may be performed using a variety of optical based methods. Simple contrast imaging can be used, or more sophisticated spectroscopic methods based on absorbance, luminescence or Raman scattering. If more sophisticated spectral analysis is needed, such as for resonant Raman scattering, the collection optics may include a spectrometer or continuously tunable bandpass filter placed in front of the detector. In order to achieve significant absorbance changes, high concentrations of dyes may be used and the number of cells may be increased to achieve significant changes in optical density. In many embodiments, the optical based methods may rely on fluorescence and/or luminescence. Light emitting diodes are one source of light. It will also be understood that although the term light emitting diode may be commonly in the art to describe only one type of light source based on diode emission, the term light emitting diodes is to be construed broadly to cover all forms of light emitting diode sources, including diode lasers, such as semiconductor diode lasers, and superluminescent diodes.

The wavelength of light used to image the cell colonies may also be controlled by the use of a narrow bandwidth filter. The filter may be tunable so that multiple bandwidths can be selected depending upon the fluorescent label used or multiple fixed wavelength filters may be used.

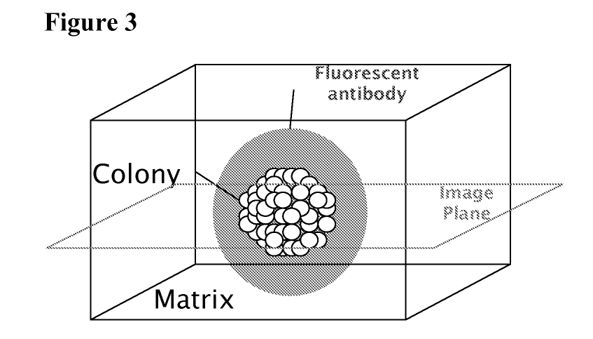

In many embodiments, cells may contain an expression system which causes the protein of interest to be secreted from the cell colony into the surrounding medium. If the expressed protein is secreted into the culture medium, then typically the expression vector may contain a suitable signal sequence that directs the secretion of the molecule to the culture medium. A fluorescent antibody, for example, that is specific for the molecule of interest may then be used for the subsequent identification of cell colonies expressing the molecule of interest. FIG. 3 illustrates a colony growing in a semi-solid culture medium in the presence of a fluorescent antibody. The fluorescent antibody binds the molecule produced by the colony and forms a precipitate around the colony resulting in a fluorescent halo around the colony.

Other suitable labels for the antibody or other detection molecule include, but are not limited to, a cyanine, an oxazine, a thiazine, a porphyrin, a phthalocyanine, a fluorescent infrared-emitting polynuclear aromatic hydrocarbon such as a violanthrone, a fluorescent protein, a near IR squaraine dye, a fluorescein, a 6-FAM, a rhodamine, a Texas Red, a tetramethylrhodamine, a carboxyrhodamine, a carboxyrhodamine 6G, a carboxyrhodol, a carboxyrhodamine 110, a Cascade Blue, a Cascade Yellow, a coumarin, Cy2®, Cy3®, Cy3.5®, Cy5®, Cy5.5®, a Cy-Chrome, a phycoerythrin, PerCP (peridinin chlorophyll-a Protein), PerCP-Cy5.5, JOE (6-carboxy-4′,5′-dichloro-2′,7′-dimethoxyfluorescein), NED, ROX (5-(and -6)-carboxy-X-rhodamine), HEX, Lucifer Yellow, Marina Blue, Oregon Green 488, Oregon Green 500, Oregon Green 514, Alexa Fluor® 350, Alexa Fluor® 430, Alexa Fluor® 488, Alexa Fluor® 532, Alexa Fluor® 546, Alexa Fluor® 568, Alexa Fluor® 594, Alexa Fluor® 633, Alexa Fluor® 647, Alexa Fluor® 660, Alexa Fluor® 680, a fluorescein isothiocyanate (e.g., fluorescein-5-isothiocyanate), a 5-FAM (5-carboxyfluorescein), a 6-FAM (6-carboxyfluorescein), a 5,6-FAM, a 7-hydroxycoumarin-3-carboxamide, a 6-chloro-7-hydroxycoumarin-3-carboxamide, dichlorotriazinylaminofluorescein, a tetramethylrhodamine-5 (and -6)-isothiocyanate, a 1,3-bis-(2-dialkylamino-5-thienyl)-substituted squarines, the succinimidyl esters of 5 (and 6) carboxyfluoroscein, a 5 (and 6)-carboxytetramethylrhodamine, a fluorescein maleimide, a 7-amino-4-methylcoumarin-3-acetic acid, a 7-amino-4-methylcoumarin-3-acetic acid, BODIPY FL, BODIPY FL-Br2, BODIPY 530/550, BODIPY 558/568, BODIPY 564/570, BODIPY 576/589, BODIPY 5811591, BODIPY 630/650, BODIPY 650/665, BODIPY R6G, BODIPY TMR, BODIPY TR, conjugates thereof, and combinations thereof.

Other suitable labels may utilize nanocrystals conjugated to the probe. Each of the characteristics of nanocrystals as described herein is an example of characteristics that can be used in accordance with the present invention.

Some characteristics of nanocrystals include that they can be produced in a narrow size distribution and, since the spectral characteristics are a function of the size, can be excited to emit a discrete fluorescence peak of narrow bandwidth. In other words, the ability to control the spectral characteristics of nanocrystals (e.g., narrow bandwidth, discrete emission wavelengths, a single wavelength can excite an array of nanocrystals with different emissions) are some of the major advantages for their use. Another advantage of the nanocrystals is their resistance toward photobleaching under light sources. As known in the art, a manual batch method may be used to prepare semiconductor nanocrystals of relative monodispersity (e.g., the diameter of the core varying approximately 10% between quantum dots in a preparation; e.g., see Bawendi et al., J. Am. Chem. Soc. 115:8706 (1993)).

The term “semiconductor nanocrystal” and “quantum dot” are used interchangeably herein and refer to an inorganic crystallite of about 1 nm or more and about 1000 nm or less in diameter or any integer or fraction of an integer there between.

Semiconductor nanocrystals are quantum dots that can be excited, e.g., with a single excitation light source, resulting in a detectable fluorescence emission (Wang, C., et al. Science 291:2390-2 (2001)). In some embodiments, they have a substantially uniform size of less than 200 Angstroms or have a substantially uniform size in the range of sizes of between from about 1 nm to about 5 nm, or less than 1 nm. Methods for making semiconductor nanocrystals are known in the art. One nonlimiting method of making semiconductor nanocrystals is by a continuous flow process (e.g., see U.S. Pat. No. 6,179,912). In some embodiments, quantum dots are comprised of a Group 1′-VI semiconductor material (e.g., ZnS or CdSe), or a Group III-V semiconductor material (e.g., GaAs). However for some embodiments, a desirable feature of quantum dots when used for nonisotopic detection applications is that the quantum dots are water-soluble. The following provide descriptions related to nanocrystals, quantum dots, semiconductor nanocrystal, and the like: U.S. Pat. Nos. 6,838,243; 6,955,855 and 7,060,252.

Semiconductor nanocrystals can be made from essentially any material and by any technique that produces semiconductor nanocrystals having emission characteristics useful in the methods, articles, assays and compositions taught herein. Semiconductor nanocrystals have absorption and emission spectra that typically depend on their size, size distribution and composition. Suitable methods of production are disclosed, for example, in U.S. Pat. No. 6,048,616; 5,990,479; 5,690,807; 5,505,928; or 5,262,357; PCT Publication No. WO 99/26299; Murray et al., J. Am. Chem. Soc. 115:8706-8715; and Guzelian et al., J. Phys. Chem. 100:7212-7219 (1996).

In some embodiments, a label is an enzyme. Suitable enzymes, which can create a detectable signal in the presence of appropriate substrates and assay conditions, include, but are not limited to, alkaline phosphatase, horseradish peroxidase, β-lactamase, β-galactosidase, glucose oxidase, galactose oxidase, neuraminidase, a bacterial luciferase, an insect luciferase and a sea pansy luciferase (e.g., Renilia koefiikeri).

In other embodiments, the expression system that is used to express the protein of interest may result in the expression of the protein of interest on the surface of a cell, such as the cell membrane. Vectors, such as expression vectors, containing coding sequences may be designed with signal sequences which direct secretion of the coding sequences through a particular cell membrane. A fluorescent antibody, for example, may then be used for the subsequent identification of cell colonies expressing the protein of interest.

In further embodiments, the cell colony may be made permeable using a cell permeablization agent, such that a fluorescent antibody for example, can enter the cell colony and associate with the molecule of interest, while still maintaining the viability of the cell colony.

In some embodiments, the cell colony may comprise an expression vector in which a protein of interest is fused to a reporter molecule or sequence tag, such as green fluorescent protein (GFP). In these embodiments, expression of the protein of interest also results in the expression of the reporter which provides for the identification of the cell colony without the need of adding an external labeled detector molecule. The unique sequence tag may be added to the nucleotide sequence encoding the protein by recombinant DNA techniques, creating a protein that can be recognized by an antibody specific for the tag peptide, for example. A wide variety of reporters may be used in accordance with the present invention with some reporters providing conveniently detectable signals (e.g. by fluorescence). By way of example, a reporter gene may encode an enzyme which catalyses a reaction, which alters light absorption properties. Examples of reporter molecules include but are not limited to β-galactosidase, invertase, green fluorescent protein, β-lactamase, luciferase, chloramphenicol, acetyltransferase, β-glucuronidase, exo-glucanase and glucoamylase. For example, fluorescently labeled biomolecules specifically synthesized with particular chemical properties of binding or association may be used as fluorescent reporter molecules. Fluorescently labeled antibodies are particularly useful reporter molecules due to their high degree of specificity for attaching to a single molecular target in a mixture of molecules as complex as a cell, tissue or extract of either.

The GFP of the jellyfish Aequorea Victoria is a protein with an excitation maximum at 395 nm and an emission maximum at 510 nm and does not require an exogenous factor. The properties and uses of GFP for the study of gene expression and protein localization have been discussed in, for example, Nat Cell Biol 4, E15-20 (2002); Biochemistry 13, 2656-2662 (1974); Photochem. Photobiol. 31, 611-615 (1980); Science 263, 12501-12504 (1994); Curr. Biology 5, 635-642 (1995); and U.S. Pat. No. 5,491,084.

A wide variety of ways to measure fluorescence are available. For example, some fluorescent reporter molecules exhibit a change in excitation or emission spectra, some exhibit resonance energy transfer where one fluorescent reporter loses fluorescence, while a second gains in fluorescence, some exhibit a loss (quenching) or appearance of fluorescence, while some report rotational movements.

In some embodiments, multispectral imaging could also be used. In these embodiments, multiple cell products could be monitored by having the fluorescent label for each cell product have an emission and/or excitation wavelength that is unique. For example, cell colonies could be selected for having high production of a molecule of interest and low production of an undesired molecule or contaminant.

In many embodiments, the methods may be used to automate selection of cell colonies which express or secrete increased levels of a molecule of interest. The term “increased level” means a level production of the molecule of interest that is significantly greater in the selected and picked colony than in the population of cells from which the colony was derived. In some embodiments, the molecule of interest is a biopharmaceutical protein, such as a protein that is useful in the treatment or diagnosis of disease.

Such cells may be detected according to, for example, the brightness of the fluorescence of the cell colony which will correlate with the amount of a molecule of interest that is expressed. The volume of fluorescence associated with a colony may also correlate with the level of production of a molecule of interest. The size of the colony when imaged under white light may serve as an indication of enhanced growth rate. As described above, the present invention might also be suited to the recovery of cell colonies producing membrane bound and secreted proteins.

Post-transcriptional gene silencing mediated by double-stranded RNA (dsRNA) is a conserved cellular defense mechanism for controlling the expression of foreign genes. It is thought that the random integration of elements such as transposons or viruses causes the expression of dsRNA, which activates sequence-specific degradation of homologous single-stranded mRNA or viral genomic RNA. The silencing effect is known as RNA interference (RNAi). The mechanism of RNAi involves the processing of long dsRNAs into duplexes of 21-25 nucleotide RNAs. These products are called small interfering or silencing RNAs (siRNAs) which are the sequence-specific mediators of mRNA degradation.

In differentiated mammalian cells, dsRNA >30 bp has been found to activate the interferon response leading to shut-down of protein synthesis and non-specific mRNA degradation. However this response can be bypassed by using siRNA duplexes of about 19-25 nucleotides, allowing gene function to be analyzed in cultured mammalian cells. In mammals, RNAi can be triggered by delivering either short dsRNA molecules (siRNAs) directly into the cell, or by delivering DNA constructs that produce the dsRNA within the cell.

In some embodiments, because RNAi may induce alterations in gene expression and morphological changes in cells, the methods described herein may be used to identify and select cells for further analysis with an altered phenotype resulting from RNAi.

In other embodiments, differences between transformed and non transformed cells may also be detected for example by the presence or absence of certain cell surface markers. Such assays may be used to assay for the transforming abilities of viruses or chemicals, for example.

In further embodiments, the methods described herein may be used to select for cells transfected with a gene. In general, selection of a cell with a transfected gene may utilize a dominant selective marker, such as neomycin resistance. The high efficiency of the automated methods described here could make such a marker unnecessary as cells could be plated at limiting dilutions and colonies expressing the desired gene selected for further analysis.

In other embodiments, proteins which are post translationaly modified, such as erythropoietin or tissue plasminogen activator which are modified with sugar residues may be selected with a labeled lectin.

In selecting colonies for picking, a single parameter such as white light volume or fluorescence volume may be considered. In other embodiments, two or more parameters may be combined, for example a ratio of one parameter over another may be calculated and used to select colonies for picking. In many embodiments, two or more parameters are considered sequentially. In these embodiments, a threshold value may be set for each parameter so that every colony considered for picking may be above or below each threshold as desired.

The following examples are intended to illustrate but not limit the invention.

### EXAMPLE 1

This example illustrates the increase in productivity obtained by selecting colonies using three different methods. The CHO cell line 48B4, obtained from the American Type Culture Collection (Atlanta, Ga.), producing IgG, was seeded in a semi-solid culture medium at a density of 500 cells/ml. The media used was CLONEMATRIX™ from Genetix USA Inc. (Boston, Mass.; catalog no. K8500). The media is supplied as a concentrate and was prepared according to the manufacturers instructions. For experiments using fluorescence detection, CLONEDETECT™ FITC labeled anti-human IgG reagent (Genetix USA Inc., Boston, Mass.; catalog no. K8200) was added to the culture media according to the manufacturers instructions. To ensure even distribution throughout the medium, the cells were mixed by repeated inversion and then plated in 6-well culture plates at about 2 ml/well and incubated at 37° C.

On the eleventh day of culture, the culture plates were placed in a CLONEPIX FL™ instrument supplied by Genetix USA Inc. (Boston, Mass.). The colonies were imaged and colonies picked and transferred to a 96-well culture plate. The imaging was performed using both white light and fluorescence analysis. Three different methods were used to select colonies for picking. In the first method, the volume of a colony was determined using fluorescence detection and that value divided by the volume of the colony determined using white light detection. The colonies having the largest ratios were selected for picking (Ratio method). In the second method, colonies were selected based solely on the size of the colony as determined using fluorescence detection and the largest colonies selected for picking (Fluorescence volume method). In the third method, colonies having a minimum size as determined using white light detection were selected and then, within that population of colonies, those with the largest size, as determined by fluorescence detection, were selected for picking (Sequential method). Colonies selected solely based on white light imaging were used as a baseline control.

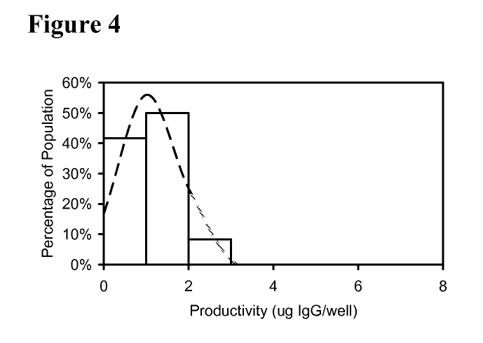

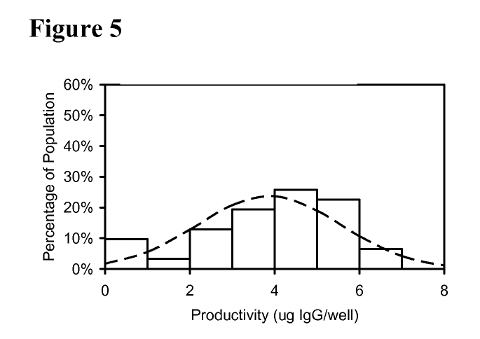

Picked colonies were transferred to individual wells of a 96-well culture plate and the viability and IgG production of each colony determined. The distribution of IgG productivity of the control white light selected colonies is illustrated in FIG. 4 and the distribution of IgG productivity of the white light-fluorescence sequentially selected colonies is illustrated in FIG. 5. The viability of the white light selected colonies was 90% and of the sequentially selected colonies, 80%.

TABLE 1

| | Productivity increase | | |
|---|---|---|---|
| Selection Method | over control | n | p |
| Ratio | 1.7 | 96 | <0.0001 |
| Fluorescence volume | 2.3 | 45 | <0.0001 |
| Sequential | 3.5 | 40 | <0.0001 |

A comparison of the increased productivity achieved by each method is given in Table 1. Each of the three methods provided a statistically significant improvement over simple white light based selection (p<0.0001). The sequential selection method provided an approximately 2 fold greater improvement in IgG productivity compared to the ratio method.

All publications, patents and patent applications mentioned in this specification are herein incorporated by reference in their entirety into the specification to the same extent as if each individual publication, patent or patent application was specifically and individually indicated to be incorporated herein by reference.

It will be appreciated that although particular embodiments of the invention have been described herein, many modifications, additions and/or substitutions may be made within the spirit and scope of the present invention.

What is claimed is:

1. A method for automated selecting of colonies of cells producing a molecule of interest, the method comprising:
a) providing cell colonies in a semi-solid medium or on a substrate;
b) contacting the cells with a label capable of binding the molecule of interest;
c) placing the cell colonies in a robotic device having an image capturing function;
d) imaging the cell colonies using white light and at a wavelength of light passed by a narrow bandwidth filter;
e) selecting cell colonies having a size greater than a desired minimum size based on the white light image; and
f) selecting from the population of cell colonies having the desired minimum size based on the white light image, cell colonies having a size greater than a minimum size based on the narrow bandwidth filtered image.

2. The method of claim 1, further comprising picking the cell colonies selected in step f, and transferring them to a multi-well culture plate.

3. The method of claim 2, wherein the label is a fluorescent or luminescent label having an emission wavelength.

4. The method of claim 3, wherein the wavelength of light passed by the narrow bandwidth filter corresponds to the emission wavelength of the fluorescent or luminescent label.

5. The method of claim 2, wherein the cell colonies are provided in a semi-solid medium.

6. The method of claim 2, wherein the cell colonies are provided on a substrate.

7. The method of claim 3, wherein the fluorescent label is selected from the group consisting of a fluorescein, a rhodamine, a Texas Red, and a fluorescein isothiocyanate (e.g., fluorescein-5-isothiocyanate).
